(19) United States
(12) Patent Application Publication
(10) Pub. No.: US 2020/0266954 A1
(43) Pub. Date: Aug. 20, 2020

(54) Method And Apparatus For User Equipment Processing Timeline Enhancement In Mobile Communications

(71) Applicant: MediaTek Singapore Pte. Ltd., Singapore (SG)

(72) Inventors: Abdellatif Salah, Cambridge (GB); Mohammed S. Aleabe Al-Imari, Cambridge (GB); Christopher William Pim, Cambridge (GB); Miquel Eduard Oliver Cardona, Cambridge (GB); Francesc Boixadera-Espax, Cambridge (GB); James Daniel Northrop, Cambridge (GB); Abdelkader Medles, Cambridge (GB); Peter Keeling, Cambridge (GB); Sylvio Paul Mathieu Bardes, Cambridge (GB)

(21) Appl. No.: 16/789,740

(22) Filed: Feb. 13, 2020

Related U.S. Application Data
(60) Provisional application No. 62/805,363, filed on Feb. 14, 2019.

(51) Int. Cl. H04L 5/00; H04W 72/12; H04L 1/18

(52) U.S. Cl. CPC H04L 5/0055; H04L 1/1812; H04L 1/1825; H04W 72/1231

(57) ABSTRACT

Various solutions for processing timeline enhancement with respect to user equipment and network apparatus in mobile communications are described. An apparatus may determine whether a latency requirement of a service is less than a threshold value. The apparatus may use a first processing time capability to perform a transmission in an event that the latency requirement of the service is not less than the threshold value. The apparatus may use a second processing time capability to perform the transmission in an event that the latency requirement of the service is less than the threshold value. The apparatus may apply a scheduling restriction/optimization to perform the transmission when using the second processing time capability.

### CROSS REFERENCE TO RELATED PATENT APPLICATION(S)

The present disclosure is part of a non-provisional application claiming the priority benefit of U.S. Patent Application No. 62/805,363, filed on 14 Feb. 2019, the content of which being incorporated by reference in its entirety.

### TECHNICAL FIELD

The present disclosure is generally related to mobile communications and, more particularly, to processing timeline enhancement with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), more aggressive user equipment (UE) processing timeline for uplink transmission (e.g., physical uplink shared channel (PUSCH) preparation) and downlink reception (e.g., physical downlink shared channel (PDSCH) processing) is proposed to reduce transmission latency and facilitate uplink/downlink transmissions. For example, UE processing time N1 is defined as the time needed for the PDSCH decoding and the hybrid automatic repeat request-acknowledgement (HARQ-ACK) feedback preparation. UE processing time N2 is defined as the PUSCH preparation time. The UE processing timeline may be dominated by N1 and/or N2. Further enhancement to the UE processing timeline is discussed in NR to further reduce the latency and accommodate larger number of uplink/downlink transmissions.

In order to satisfy the stringent requirements of the ultra-reliable and low latency communications (URLLC) traffic in terms of latency and reliability, further reduction of the minimum UE processing time may be needed for some cases. New reduced processing time capability could allow for improved HARQ-based operation and the possibility to accommodate multiple HARQ transmissions within the latency budget.

However, further reducing the UE processing time will lead to increased UE complexity and an additional burden on the UE implementation. Forcing to minimize the UE processing time will lead to severe challenges on UE implementation and cost. It is therefore reasonable to focus on some specific use cases with the most critical requirements and with more potential for further processing time improvement. Thus, an intermediate solution is needed to allow for stringent processing time requirements on some critical use cases while still not putting a lot of pressure on the overall UE implementation and architecture.

Accordingly, how to improve UE processing timeline and avoid increasing complexity on the UE implementation and architecture becomes an important aspect for the newly developed wireless communication network. Therefore, it is needed to provide proper schemes for the UE to shorten processing timeline and keep some flexibility on design complexity.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to processing timeline enhancement with respect to user equipment and network apparatus in mobile communications.

In one aspect, a method may involve an apparatus determining whether a latency requirement of a service is less than a threshold value. The method may also involve the apparatus using a first processing time capability to perform a transmission in an event that the latency requirement of the service is not less than the threshold value. The method may further involve the apparatus using a second processing time capability to perform the transmission in an event that the latency requirement of the service is less than the threshold value. The method may further involve the apparatus applying a scheduling restriction/optimization to perform the transmission when using the second processing time capability.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising determining whether a latency requirement of a service is less than a threshold value. The processor may also perform operations comprising using a first processing time capability to perform a transmission in an event that the latency requirement of the service is not less than the threshold value. The processor may further perform operations comprising using a second processing time capability to perform the transmission in an event that the latency requirement of the service is less than the threshold value. The processor may further perform operations comprising applying a scheduling restriction/optimization to perform the transmission when using the second processing time capability.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT) and Industrial Internet of Things (IIoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example table under schemes in accordance with implementations of the present disclosure.

FIG. 2 is a block diagram of an example communication apparatus and an example network apparatus in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to processing timeline enhancement with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, more aggressive UE processing timeline for uplink transmission (e.g., PUSCH preparation) and downlink reception (e.g., PDSCH processing) is proposed to reduce transmission latency and enable additional HARQ retransmissions within the URLLC latency budget, hence improving both the reliability and the system efficiency. For example, UE processing time N1 is defined as the time needed for the PDSCH decoding and the HARQ-ACK feedback preparation. UE processing time N2 is defined as the PUSCH preparation time. The UE processing timeline may be dominated by N1 and/or N2. Further enhancement to the UE processing timeline is discussed in NR to further reduce the latency and accommodate larger number of uplink/downlink transmissions.

In order to satisfy the stringent requirements of the URLLC traffic in terms of latency and reliability, further reduction of the minimum UE processing time may be needed for some latency-critical use cases. New reduced processing time capability could allow for improved HARQ-based operation and the possibility to accommodate multiple HARQ transmissions within the latency budget. However, further reducing the UE processing time will lead to increased UE complexity and an additional burden on the UE implementation. For example, in order to further reduce the UE processing time, the UE may need to be implemented by hardware components with better performance which leads to higher manufacture cost. To shorten the UE processing timeline, more complex and massive computation may also be raised on the UE which leads to further power consumption and complicated UE implementation. Forcing to minimize the UE processing time will lead to severe challenges on UE implementation and cost. It is therefore reasonable to focus on some specific use cases with the most critical requirements and with more potential for further processing time improvement. Accordingly, an intermediate solution is needed to allow for stringent processing time requirements on some critical use cases while still not putting a lot of pressure on the overall UE implementation and architecture.

In view of the above, the present disclosure proposes a number of schemes pertaining to processing timeline enhancement with respect to the UE and the network apparatus. According to the schemes of the present disclosure, some scheduling restrictions that will help reduce the complexity of the UE implementation with very minor performance impact will be proposed. The UE may be configured to determine a latency requirement of a service for determining whether to apply the scheduling restriction/optimization. For some generic services where the latency requirement is not stringent, the UE may not need to apply the scheduling restriction. For some specific services where the latency requirement is stringent, the UE may apply the scheduling restriction/optimization to reduce the processing time. Accordingly, the UE may have flexibility to enhance the processing timeline without a lot of pressure on the UE implementation and architecture.

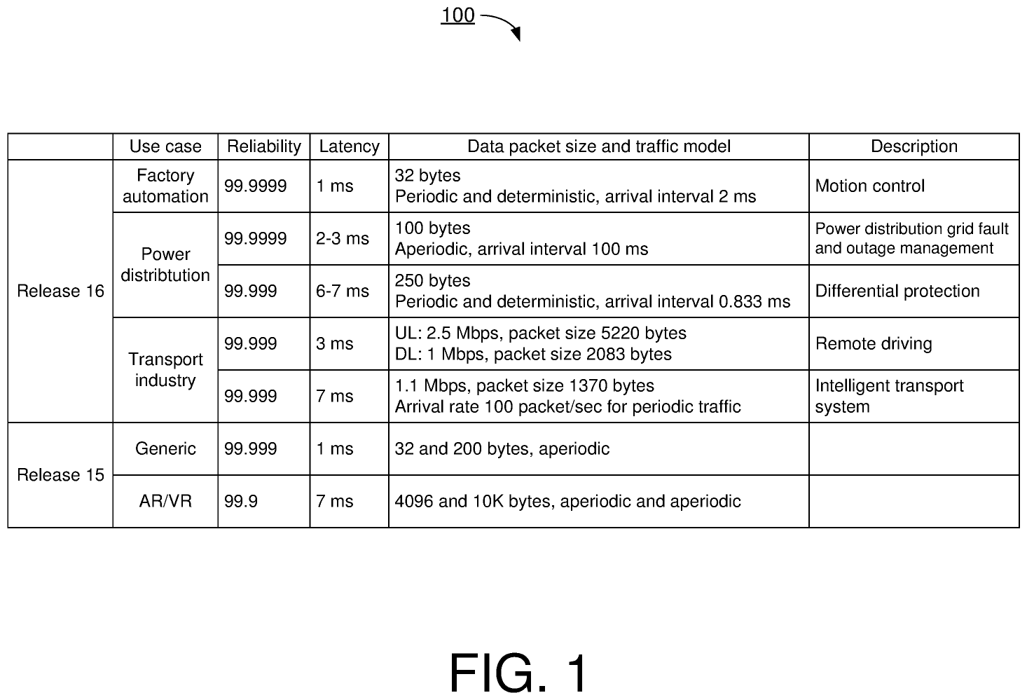

FIG. 1 illustrates an example table 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an loT network, an NB-IoT network or an IIoT network). Table 100 illustrates some URLLC use cases in 3^{rd} Generation Partnership Project (3GPP) release 15 and release 16. It could be observed from table 100 Error! Reference source not found. that the release 16 factory automation use case has the most stringent requirements in terms of latency and reliability amongst the release 15 and release 16 use cases. However, the URLLC traffic for factory automation is periodic and deterministic hence predictable and capability #3 could be restricted to periodic and deterministic traffic (e.g., for factory automation). This traffic model property is of great importance and allows for reducing the amount of uncertainty at the UE processing. Therefore, a significant amount of optimization may be anticipated by the UE before the reception or the transmission of the packet. In addition, the factory automation use case is associated with small packet sizes (e.g., 32 bytes) which may be also exploited for further optimization.

As a result, the use cases and the service types may be taken into consideration to introduce a new UE processing time capability (e.g., capability #3). The new UE processing time capability (e.g., capability #3) may be used for critical use cases (e.g., factory automation). The new UE processing time capability with restricted traffic types may be introduce for the enhanced URLLC (eURLLC). The remaining use cases (e.g., power distribution, transport industry and release 15 use cases) requirements as listed in table 100 may be easily met with the release 15 UE processing time capability (e.g., capability #2).

Specifically, the UE may be configured to determine the use case and/or the service type of a transmission. Then, the UE may be able to determine a proper UE processing time capability to perform the transmission according to the requirements of the use case/service type. For example, the UE may be configured to determine whether a latency requirement of a service is less than a threshold value. The UE may be configured to use a first processing time capability (e.g., capability #2) to perform a transmission in an event that the latency requirement of the service is not less than the threshold value (e.g., 1 ms). The UE may be configured to use a second processing time capability (e.g., capability #3) to perform the transmission in an event that the latency requirement of the service is less than the threshold value (e.g., 1 ms). The UE may be configured to apply a scheduling restriction/optimization to perform the transmission when using the second processing time capability. Some scheduling restrictions may be introduced to further simplify the UE processing and alleviate the pressure on the UE implementation. The UE may use the scheduling restriction/optimization to reduce the processing time for meeting the critical latency requirement. The transmission may comprise an initial transmission and a retransmission. The service may comprise a URLLC service or an eURLLC service.

The first processing time capability (e.g., capability #2) may comprise a first normal processing time N1 and a second normal processing time N2. The second processing time capability (e.g., capability #3) may comprise a first specific processing time N1′ and a second specific processing time N2′. The first specific processing time N1′ is less than the first normal processing time N1. The second specific processing time N2′ is less than the second normal processing time N2. N1 and N1′ may be defined as the time needed for the PDSCH decoding and the HARQ-ACK feedback preparation. N2 and N2′ may be defined as the PUSCH preparation time. The value of the normal processing time and the specific processing time may be pre-stored in the UE or configured by the network node. For example, the specific processing time N1′/N2′ may be configured by the radio resource control (RRC) signalling or dynamically signalled. The UE may be configured to receive a configuration of the specific processing time.

In some implementations, the scheduling restriction/optimization may comprise transport block size (TBS) restrictions. For example, the scheduling restriction/optimization may comprise a restricted range of TBS values. The TBS of downlink reception and/or uplink transmission cannot exceed the restricted range. 5˜10 TBS values may be configured by the network node via the radio resource control (RRC) signalling. Alternatively, the scheduling restriction/optimization may comprise an upper-bound on the TB sizes or the data rates. Alternatively, the scheduling restriction/optimization may comprise a restricted maximum bandwidth (BW) size. In general, reducing the range of uncertainty will help a lot in reducing the UE processing time. With such scheduling restrictions, the UE processing time (e.g., downlink data decoding time and/or uplink data preparation time) may be reduced since the packet size is restricted in a small range. On the other hand, the UE may benefit from a prior/advance knowledge of the TBS or fixed TBS. The TBS may be signalled in advance or fixed to one constant value which is semi-statically configured to the UE. The priori/advance knowledge of the TBS or the TBS range allows the UE to anticipate a lot of processing and calibration (e.g., user plane (U-plane) and/or layer 1(L1) preparation) which could save time for the UE to focus on the packet decoding or the packet preparation when the packet arrives.

In some implementations, the scheduling restriction/optimization may comprise cancelling/removing a support of a code block group (CBG) transmission and the 3GPP ciphering. The UE may be configured not to receive and/or transmit multiple CBs (e.g., CBG) at a time. Similarly, the UE may be configured not to perform the ciphering when perform the transmission for saving time. Alternatively, the scheduling restriction/optimization may comprise cancelling/removing a support of a hybrid automatic repeat request-acknowledgement (HARQ) codebook. The UE may be configured to transmit a HARQ feedback (e.g., acknowledgement (ACK)/negative acknowledgement (NACK)) individually rather than assemble multiple ACK/NACK as a HARQ codebook for reducing latency.

In some implementations, the scheduling restriction/optimization may comprise restricting a HARQ feedback to a specific physical uplink control channel (PUCCH) format (e.g., PUCCH format_0) and cancelling multiplexing of a HARQ feedback and other uplink control information (UCI). Specifically, the HARQ feedback preparation and transmission will consume a considerable amount of the UE processing time and could be simplified. One possibility is to restrict the HARQ feedback to specific PUCCH formats and decouple the HARQ feedback from all other UCI information. For example, only HARQ-ACK reporting on PUCCH resources may be allowed and no channel state information (CSI) multiplexing on the same PUCCH. The CSI feedback may be sent on different PUCCH or dropped by the UE. This may save the time on the HARQ-ACK and the CSI multiplexing efforts. Thus, the UE may be configured to transmit the HARQ feedback only on the specific PUCCH formats. The UE may be configured not to multiplex the HARQ feedback with another UCI.

In some implementations, ensuring a small UCI payload means the use of sequence based or Reed-Muller encoding instead of Polar encoding and this will help reducing the processing time. Thus, the scheduling restriction/optimization may comprise using a sequence based or Reed-Muller encoding to encode a UCI payload. The UCI payload may be restricted to a small size (e.g., UCI bits ≤11). The UE processing time N1 may be reduced for this case compared to UCI bits ≥11.

In some implementations, a prior/advance knowledge of the PUCCH format may be very beneficial. The UE may not need to decode the downlink control information (DCI) to determine the PUCCH format and it may have an advance knowledge of the PUCCH resource set and advance knowledge of the UCI payload. Also, an advance knowledge of the PUCCH location in time and the transmit power control (TPC) command may also be very useful. Currently, the UE needs to finish the PDCCH decoding to determine the PUCCH location in time. With the advance knowledge of the PUCCH location in time, the UE may save the time for decoding the PDCCH. Similarly, the UE may save time with the advance knowledge of the TPC command. Thus, the UE may be configured to receive a prior/advance knowledge of the PUCCH format or TPC command. The UE may be configured to determine the PUCCH format or TPC command according to the advance knowledge without decoding the DCI. The prior/advance knowledge of PUCCH related information may help accelerate the UE processing time.

In some implementations, to help improve the PUSCH processing time (e.g., N2), cancelling/removing the support of the UCI piggy-backing on the PUSCH will help reducing the PUSCH processing time. Separation of uplink carrying ACK/NACK from uplink carrying PUSCH data will help reducing the PUSCH processing time. Thus, the scheduling restriction/optimization may comprise cancelling a support of UCI piggybacking on a PUSCH transmission. The UE may be configured not to transmit the UCI with the PUSCH data. On the other hand, possible optimization may be introduced for PUSCH retransmission. Layer 1 (L1) and layer 2 (L2) may require less processing in retransmission. Some data and parameters used in the initial transmission may be re-used in the retransmission to reduce UE processing time.

All the aforementioned proposals to reduce the UE processing time may be specified and may be enabled/disabled semi-statically or dynamically to the UE. The aforementioned scheduling restrictions may be defined as UE capabilities (e.g., capability #3) and the UE may report its support or not of that feature while meeting the latency requirement. For example, the UE may report its support or not of HARQ-ACK multiplexing with CSI when the eURLLC traffic is with stringent latency requirement.

### Illustrative Implementations

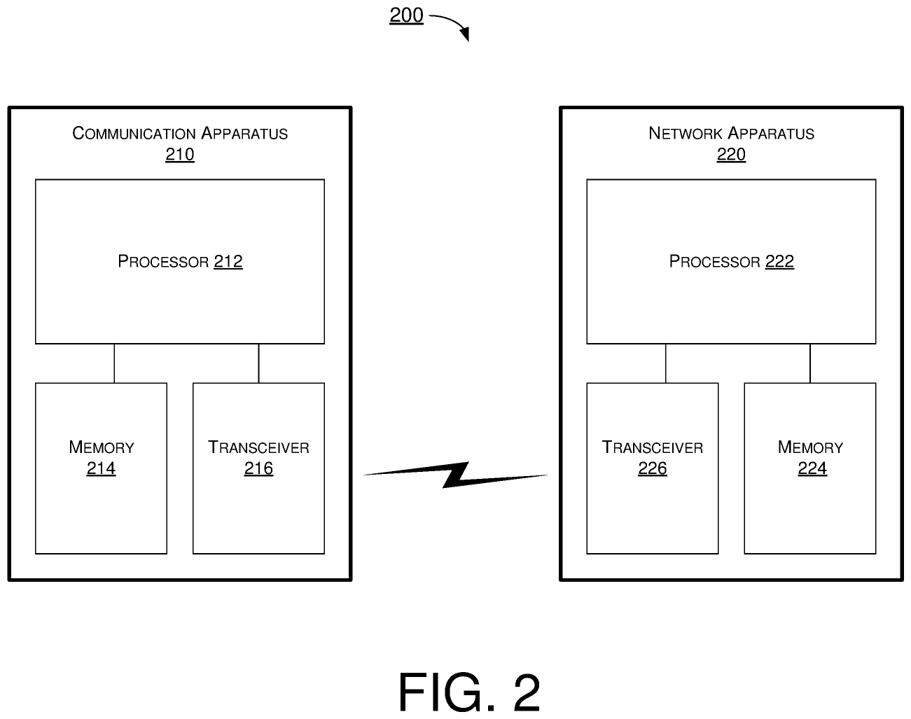

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to processing timeline enhancement with respect to user equipment and network apparatus in wireless communications, including scenarios/mechanisms described above as well as process 300 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an loT, NB-IoT, or IIoT apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a base station, a small cell, a router or a gateway. For instance, network apparatus 220 may be implemented in an eNodeB in an LTE, LTE-Advanced or LTE-Advanced Pro network or in a gNB in a 5G, NR, loT, NB-IoT or IIoT network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE and network apparatus 220 is implemented in or as a network node of a communication network.

In some implementations, processor 212 may be configured to determine the use case and/or the service type of a transmission. Then, processor 212 may be able to determine a proper UE processing time capability to perform the transmission according to the requirements of the use case/service type. For example, processor 212 may be configured to determine whether a latency requirement of a service is less than a threshold value. Processor 212 may be configured to use a first processing time capability (e.g., capability #2) to perform a transmission in an event that the latency requirement of the service is not less than the threshold value (e.g., 1 ms). Processor 212 may be configured to use a second processing time capability (e.g., capability #3) to perform the transmission in an event that the latency requirement of the service is less than the threshold value (e.g., 1 ms). Processor 212 may be configured to apply a scheduling restriction/optimization to perform the transmission when using the second processing time capability. Processor 212 may use the scheduling restriction/optimization to reduce the processing time for meeting the critical latency requirement.

In some implementations, the scheduling restriction/optimization may comprise TBS restrictions. For example, processor 212 may be configured to restrict a range of TBS values. The TBS of downlink reception and/or uplink transmission cannot exceed the restricted range. 5-10 TBS values may be configured by network apparatus 220 via the RRC signalling. Alternatively, processor 212 may be configured to restrict an upper-bound on the TB sizes or the data rates. Alternatively, processor 212 may be configured to restrict a maximum BW size. With such scheduling restrictions, processor 212 may reduce processing time (e.g., downlink data decoding time and/or uplink data preparation time) since the packet size is restricted in a small range. On the other hand, processor 212 may benefit from a prior/advance knowledge of the TBS or fixed TBS. The TBS may be signalled in advance or fixed to one constant value which is semi-statically configured to processor 212. The priori/advance knowledge of the TBS or the TBS range allows processor 212 to anticipate a lot of processing and calibration which could save time for processor 212 to focus on the packet decoding or the packet preparation when the packet arrives.

In some implementations, processor 212 may be configured to cancel/remove a support of a CBG transmission and the 3GPP ciphering. Processor 212 may be configured not to receive and/or transmit multiple CBs (e.g., CBG) at a time. Similarly, processor 212 may be configured not to perform the ciphering when perform the transmission for saving time. Alternatively, the scheduling restriction/optimization may comprise cancelling/removing a support of a HARQ codebook. Processor 212 may be configured to transmit, via transceiver 216, a HARQ feedback (e.g., ACK/NACK) individually rather than assemble multiple ACK/NACK as a HARQ codebook for reducing latency.

In some implementations, processor 212 may be configured to restrict a HARQ feedback to a specific PUCCH format (e.g., PUCCH format_0) and cancel multiplexing of a HARQ feedback and other UCI. Processor 212 may be configured to decouple the HARQ feedback from all other UCI information. For example, only HARQ-ACK reporting on PUCCH resources may be allowed and no CSI multiplexing on the same PUCCH. Processor 212 may transmit, via transceiver 216, the CSI feedback on different PUCCH or drop the CSI feedback. This may save the time on the HARQ-ACK and the CSI multiplexing efforts. Thus, processor 212 may be configured to transmit, via transceiver 216, the HARQ feedback only on the specific PUCCH formats. Processor 212 may be configured not to multiplex the HARQ feedback with another UCI.

In some implementations, ensuring a small UCI payload means the use of sequence based or Reed-Muller encoding instead of Polar encoding and this will help reducing the processing time. Thus, processor 212 may be configured to use a sequence based or Reed-Muller encoding to encode a UCI payload. The UCI payload may be restricted to a small size (e.g., UCI bits ≤11).

In some implementations, a prior/advance knowledge of the PUCCH format may be very beneficial. Processor 212 may not need to decode the DCI to determine the PUCCH format. Processor 212 may have an advance knowledge of the PUCCH resource set and advance knowledge of the UCI payload. Also, an advance knowledge of the PUCCH location in time and the TPC command may also be very useful. Currently, processor 212 may need to finish the PDCCH decoding to determine the PUCCH location in time. With the advance knowledge of the PUCCH location in time, processor 212 may save the time for decoding the PDCCH. Similarly, processor 212 may save time with the advance knowledge of the TPC command. Thus, processor 212 may be configured to receive, via transceiver 216, a prior/advance knowledge of the PUCCH format or TPC command. Processor 212 may be configured to determine the PUCCH format or TPC command according to the advance knowledge without decoding the DCI. Processor 212 may accelerate the UE processing time according to the prior/advance knowledge of PUCCH related information.

In some implementations, to help improve the PUSCH processing time (e.g., N2), processor 212 may be configured to cancel/remove the support of the UCI piggy-backing on the PUSCH for reducing the PUSCH processing time. Separation of uplink carrying ACK/NACK from uplink carrying PUSCH data will help reducing the PUSCH processing time. Thus, processor 212 may be configured to cancel a support of UCI piggybacking on a PUSCH transmission. Processor 212 may be configured not to transmit the UCI with the PUSCH data. On the other hand, possible optimization may be introduced for PUSCH retransmission. Processor 212 may reuse some data and parameters used in the initial transmission for the retransmission to reduce UE processing time.

In some implementations, the aforementioned scheduling restrictions may be defined as UE capabilities (e.g., capability #3) and processor 212 may report its support or not of that feature while meeting the latency requirement. For example, processor 212 may report, via transceiver 216, its support or not of HARQ-ACK multiplexing with CSI when the eURLLC traffic is with stringent latency requirement.

### Illustrative Processes

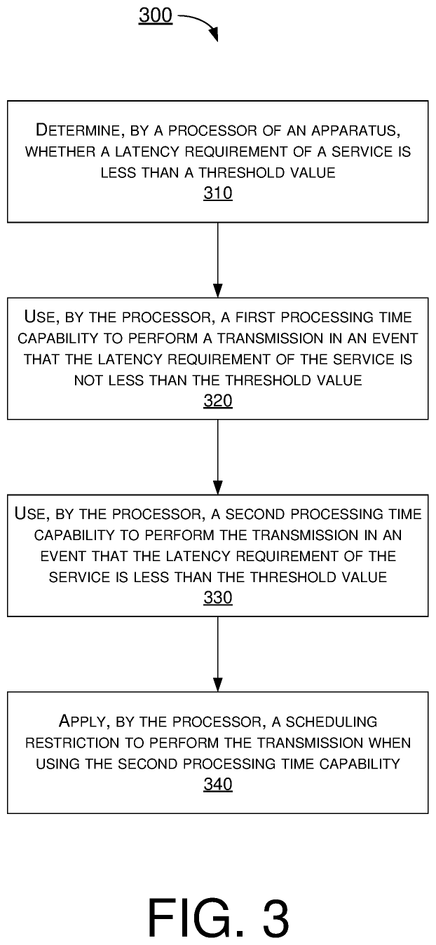

FIG. 3 illustrates an example process 300 in accordance with an implementation of the present disclosure. Process 300 may be an example implementation of above scenarios/schemes, whether partially or completely, with respect to UE processing timeline enhancement with the present disclosure. Process 300 may represent an aspect of implementation of features of communication apparatus 210. Process 300 may include one or more operations, actions, or functions as illustrated by one or more of blocks 310, 320, 330 and 340. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210. Process 300 may begin at block 310.

At 310, process 300 may involve processor 212 of apparatus 210 determining whether a latency requirement of a service is less than a threshold value. Process 300 may proceed from 310 to 320.

At 320, process 300 may involve processor 212 using a first processing time capability to perform a transmission in an event that the latency requirement of the service is not less than the threshold value. Process 300 may proceed from 320 to 330.

At 330, process 300 may involve processor 212 using a second processing time capability to perform the transmission in an event that the latency requirement of the service is less than the threshold value. Process 300 may proceed from 330 to 340.

At 340, process 300 may involve processor 212 applying a scheduling restriction/optimization to perform the transmission when using the second processing time capability.

In some implementations, the scheduling restriction/optimization may comprise a restricted range of TBS values, or an upper-bound on a TBS or a data rate.

In some implementations, the scheduling restriction/optimization may comprise a restricted maximum BW size.

In some implementations, the scheduling restriction/optimization may comprise cancelling a support of a CBG transmission or a HARQ codebook.

In some implementations, the scheduling restriction/optimization may comprise restricting a HARQ feedback to a specific PUCCH format.

In some implementations, the scheduling restriction/optimization may comprise cancelling multiplexing of a HARQ feedback and other UCI.

In some implementations, the scheduling restriction/optimization may comprise using a sequence based or Reed-Muller encoding to encode a UCI payload.

In some implementations, the scheduling restriction/optimization may comprise cancelling a support of UCI piggy-backing on a PUSCH transmission.

In some implementations, process 300 may involve processor 212 receiving an advance knowledge of a PUCCH format. Process 300 may further involve processor 212 determining the PUCCH format according to the advance knowledge without decoding DCI.

In some implementations, the service may comprise a URLLC service or an eURLLC service.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, whether a latency requirement of a service is less than a threshold value;
using, by the processor, a first processing time capability to perform a transmission in an event that the latency requirement of the service is not less than the threshold value;
using, by the processor, a second processing time capability to perform the transmission in an event that the latency requirement of the service is less than the threshold value; and
applying, by the processor, a scheduling restriction to perform the transmission when using the second processing time capability.

2. The method of claim 1, wherein the scheduling restriction comprises a restricted range of transport block size (TBS) values, or an upper-bound on a TBS or a data rate.

3. The method of claim 1, wherein the scheduling restriction comprises a restricted maximum bandwidth (BW) size.

4. The method of claim 1, wherein the scheduling restriction comprises cancelling a support of a code block group (CBG) transmission or a hybrid automatic repeat request-acknowledgement (HARQ) codebook.

5. The method of claim 1, wherein the scheduling restriction comprises restricting a hybrid automatic repeat request-acknowledgement (HARQ) feedback to a specific physical uplink control channel (PUCCH) format.

6. The method of claim 1, wherein the scheduling restriction comprises cancelling multiplexing of a hybrid automatic repeat request-acknowledgement (HARQ) feedback and other uplink control information (UCI).

7. The method of claim 1, wherein the scheduling restriction comprises using a sequence based or Reed-Muller encoding to encode an uplink control information (UCI) payload.

8. The method of claim 1, wherein the scheduling restriction comprises cancelling a support of uplink control information (UCI) piggy-backing on a physical uplink shared channel (PUSCH) transmission.

9. The method of claim 1, further comprising:
receiving, by the processor, an advance knowledge of a physical uplink control channel (PUCCH) format; and
determining, by the processor, the PUCCH format according to the advance knowledge without decoding downlink control information (DCI).

10. The method of claim 1, wherein the service comprises a ultra-reliable and low latency communications (URLLC) service or an enhanced URLLC (eURLLC) service.

11. An apparatus, comprising:
a transceiver which, during operation, wirelessly communicates with network nodes of a wireless network; and
a processor communicatively coupled to the transceiver such that, during operation, the processor performs operations comprising:
determining whether a latency requirement of a service is less than a threshold value;
using a first processing time capability to perform a transmission in an event that the latency requirement of the service is not less than the threshold value;
using a second processing time capability to perform the transmission in an event that the latency requirement of the service is less than the threshold value; and
applying a scheduling restriction to perform the transmission when using the second processing time capability.

12. The apparatus of claim 11, wherein the scheduling restriction comprises a restricted range of transport block size (TBS) values, or an upper-bound on a TBS or a data rate.

13. The apparatus of claim 11, wherein the scheduling restriction comprises a restricted maximum bandwidth (BW) size.

14. The apparatus of claim 11, wherein the scheduling restriction comprises cancelling a support of a code block group (CBG) transmission or a hybrid automatic repeat request-acknowledgement (HARQ) codebook.

15. The apparatus of claim 11, wherein the scheduling restriction comprises restricting a hybrid automatic repeat request-acknowledgement (HARQ) feedback to a specific physical uplink control channel (PUCCH) format.

16. The apparatus of claim 11, wherein the scheduling restriction comprises cancelling multiplexing of a hybrid automatic repeat request-acknowledgement (HARQ) feedback and other uplink control information (UCI).

17. The apparatus of claim 11, wherein the scheduling restriction comprises using a sequence based or Reed-Muller encoding to encode an uplink control information (UCI) payload.

18. The apparatus of claim 11, wherein the scheduling restriction comprises cancelling a support of uplink control information (UCI) piggy-backing on a physical uplink shared channel (PUSCH) transmission.

19. The apparatus of claim 11, wherein, during operation, the processor further performs operations comprising:
receiving, via the transceiver, an advance knowledge of a physical uplink control channel (PUCCH) format; and
determining the PUCCH format according to the advance knowledge without decoding downlink control information (DCI).

20. The apparatus of claim 11, wherein the service comprises a ultra-reliable and low latency communications (URLLC) service or an enhanced URLLC (eURLLC) service.
